(19) United States
(12) Patent Application Publication
(10) Pub. No.: US 2012/0148335 A1
(43) Pub. Date: Jun. 14, 2012

(54) Rail-Mountable Control Console For A Medical Apparatus

(75) Inventors: Jean-Francois Nourry, Crecy la Chapelle (FR); Thomas Lecanu, Coubron (FR)

(73) Assignee: CoActive Technologies, LLC, Newton, MA (US)

(21) Appl. No.: 13/324,065

(22) Filed: Dec. 13, 2011

(30) Foreign Application Priority Data
Dec. 13, 2010 (FR) 1060406

(51) Int. Cl. F16B 2/06

(52) U.S. Cl. 403/110

(57) ABSTRACT

A control console for an electronic medical apparatus, such as a radiography apparatus, being designed to be mounted slidably on a transverse rail. The console includes a sealed housing with a transverse groove designed to be attached to the first rail, a jaw mounted movably on the housing between a position in which the first rail is clamped between the jaw and a rear face of the housing, in order to immobilize the housing with respect to the first rail, and a position of release of the housing, in which position the housing is able to be withdrawn from the first rail. Additionally, the jaw may be mounted movably on a deck, which is fixed on an outer face of the sealed housing.

### CROSS REFERENCE TO RELATED APPLICATION

This application claims priority to France Patent Application No. 1060406 filed Dec. 13, 2010, the content of which is hereby incorporated by reference in its entirety.

### BACKGROUND

The present disclosure relates to a control console for an electronic medical apparatus able to be mounted slidably on at least one rail. More specifically, the present disclosure relates to a control console for an electronic medical apparatus, such as a radiography apparatus, the console being designed to be mounted slidably on at least a first transverse rail.

Electronic medical apparatuses are generally controlled from electronic consoles. This is especially the case with certain radiography apparatuses using X-rays. The console is generally mounted on a horizontal rail, which can be fixed to a wall, to a hospital bed or even to a stretcher.

On account of its medical use, the control console is subject to very strict hygiene and safety standards. Therefore, the control electronics of the console are protected by being enclosed in a sealed housing. Moreover, from a hygiene point of view, a sealed housing of this kind is easily washable. The console must also be able to be easily dismantled from the rails in order to use it on different rails. The manner in which the control console is attached to the rail must also allow the console to slide on the rail in order to simplify the work of the medical personnel.

In the control consoles of the prior art, at least some elements of the fixing means are arranged inside the sealed housing. This is unsatisfactory since maintenance work on the fixing means then requires dismantling the sealed housing. A maintenance procedure of this kind takes a great deal of time, since it is necessary to ensure that the housing is fully sealed after it has been re-assembled. Moreover, during such a maintenance procedure, the electronic elements are exposed to the open air and risk causing malfunctions of the control console.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

The present disclosure aims to propose control console that remedies the abovementioned drawbacks. To this end, the present disclosure proposes a control console comprising a sealed housing with a transverse groove designed to be attached to a first rail, and a jaw, which is mounted movably on the housing between a position in which the first rail is clamped between the jaw and a rear face of the housing, in order to immobilize the housing with respect to the first rail, and a position of release of the housing, in which position the housing is able to be withdrawn from the first rail. This arrangement provides a jaw that is mounted movably on a deck, which is fixed on an outer face of the sealed housing.

According to other features of the invention, the control device and the jaw are carried by the common deck in such a way as to form a module designed to be fixed against the outer face of the housing; the jaw is returned elastically to its clamping position; the movement of the jaw to its position of release is controlled by way of a drawer, which is mounted so as to slide horizontally on the deck; the drawer has locking means or mechanism for locking the jaw in the clamping position thereof; the drawer is mounted so as to slide longitudinally under the deck; the console is also able to be mounted on a second rail, which is thicker than the first rail, the console being able to be immobilized on the second rail by said jaw; the groove being sufficiently wide to accommodate the second rail; the second rail is arranged in the continuation of the first rail; the second rail having an upper face arranged below the level of the upper face of the first rail; and the groove having a stepped profile, so as to permit the simultaneous bearing of the stepped arrangement on the first rail and the bearing of the base of the groove on the second rail when the console straddles the join between the two rails; the jaw has a corner, which allows the console to be immobilized in all directions with respect to the rail; and the groove has a clearance, which allows the console to be tilted with respect to the rail when the jaw is in the position of release, in order to facilitate attachment/detachment of the console to/from the rail.

### BRIEF DESCRIPTION OF THE DRAWINGS

Other features and advantages of the invention will become apparent from reading the following detailed description, for an understanding of which reference will be made to the appended drawings in which:

FIG. 1 illustrates a perspective view showing a control console designed according to an embodiment of the invention, the console being mounted in a position straddling two rails of different dimensions;

FIG. 2 illustrates a perspective view seen from an opposite angle compared to FIG. 1 and showing the console from FIG. 1;

FIG. 3 illustrates a longitudinal cross section along the sectional plane 3-3 in of FIG. 2;

FIG. 4 illustrates an exploded perspective view showing the module comprising the mechanism for fixing the console on the rails;

FIG. 5 illustrates an exploded perspective view showing the module from FIG. 4 as assembled under the lower face of the console;

FIG. 6 illustrates a longitudinal cross section along the sectional plane 6-6 in FIG. 2.

### DETAILED DESCRIPTION

In the description below, elements having identical, analogous or similar functions will be designated by the same reference numbers. Also, in the description below, the following orientations will be adopted without implying any limitation: longitudinal orientation “L”, directed from the rear forwards; vertical orientation “V”, directed from the bottom upwards; and transverse orientation “T”, directed from left to right. These orientations are indicated by the triple axis system “L,V,T” in the figures.

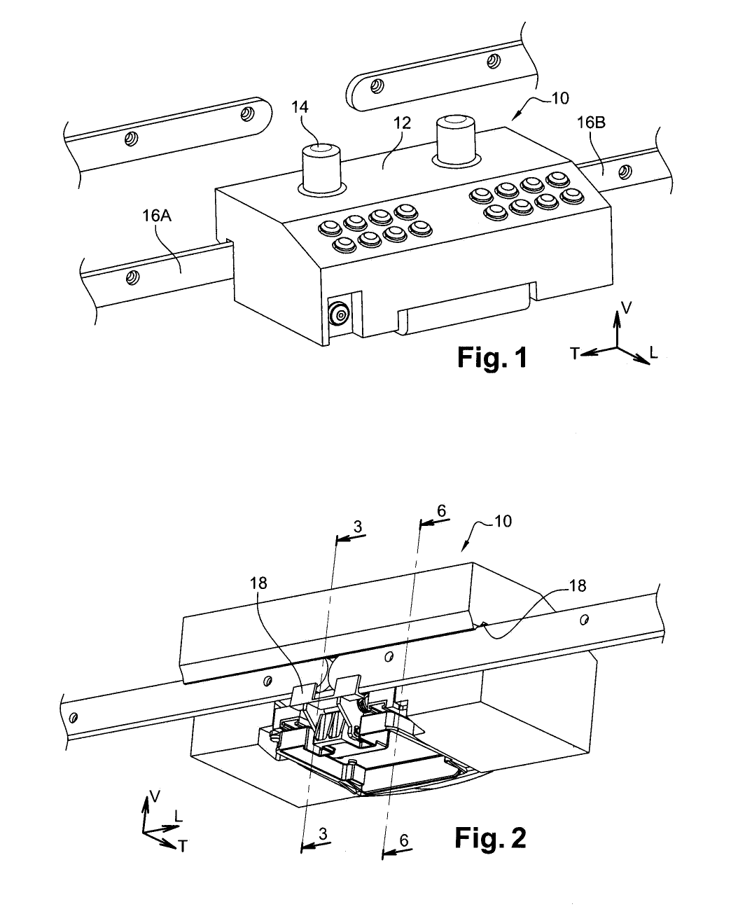

FIG. 1 illustrates a control console 10 for an electronic medical apparatus (not shown), for example a radiography apparatus using X-rays. This control console 10 may include a sealed housing 12, which contains an electronic control unit (not shown). In a known manner, a console 10 of this kind may be fitted with various data input and/or output means, which are here formed by buttons and levers 14. The console 10 may also include wired or wireless means or interfaces (not shown) for communicating with the medical apparatus via a wired or wireless connection. The console 10 may be designed to be mounted on at least one rail 16 whose main orientation is a transverse orientation. In the example shown in the figures, the console 10 may be configured to be mounted on a first rail 16A and a second rail 16B, of which the cross sections are of different sizes. For this purpose, the console 10 may include means or a mechanism for fixing on the rails 16A, 16B.

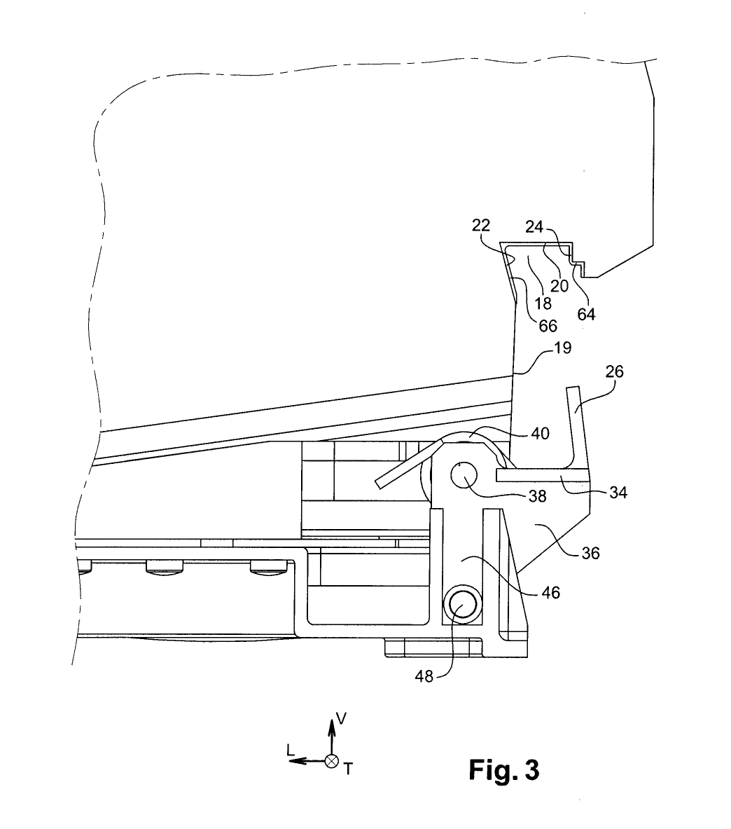

As is shown in FIGS. 2 and 3, the fixing means may include at least one transverse groove 18, which may be carried by a rear face 19 of the housing 12 and which is designed to be attached to the rails 16A, 16B. The groove 18 may be open vertically towards the bottom and open out transversely on both sides of the housing 12. The groove 18 may be delimited vertically toward the top by a base 20 and longitudinally toward the front by a first transverse wall 22 and toward the rear by a second transverse wall 24. The groove 18 may thus be designed to be attached to the rail 16A, 16B.

In this embodiment, the groove 18 may be molded integrally in the housing 12. According to an alternative embodiment (not shown) of the invention, the groove is replaced by at least one hook, which is mounted on an outer face of the housing.

When the console 10 is attached to the rail 16A, 16B via its groove 18, the weight of the console 10 may press the rear face 19 of the housing 12 flat against the rail 16A, 16B by bearing on the upper edge of the rail 16A, 16B. The console 10 is thus attached in a stable manner.

To ensure that the console 10 attached in this way is fixed to the rail 16A, 16B, the console 10 may also include at least one jaw 26, which is mounted movably on the housing 12 between: a position in which the rail 16A, 16B is clamped longitudinally between the jaw 26 and the rear face 19 of the housing 12, in order to immobilize the housing 12 with respect to the rail 16A, 16B, as is shown in FIG. 3; and a position of release (not shown) of the housing 12, in which position the housing 12 is able to be withdrawn from the rail 16A, 16B. It is possible for the jaw 26 to be actuated by a control device 28, which will be described in more detail below.

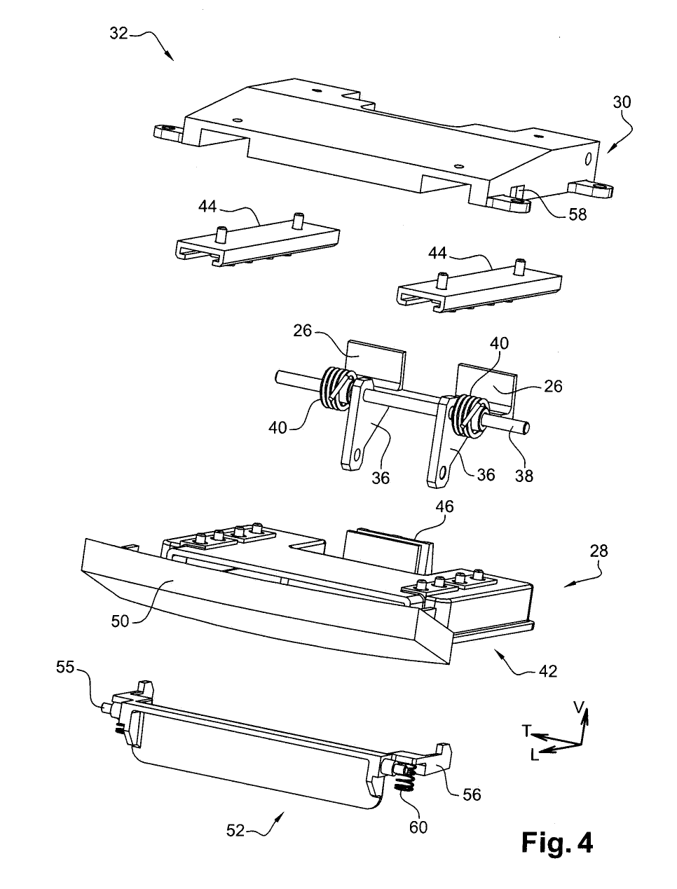

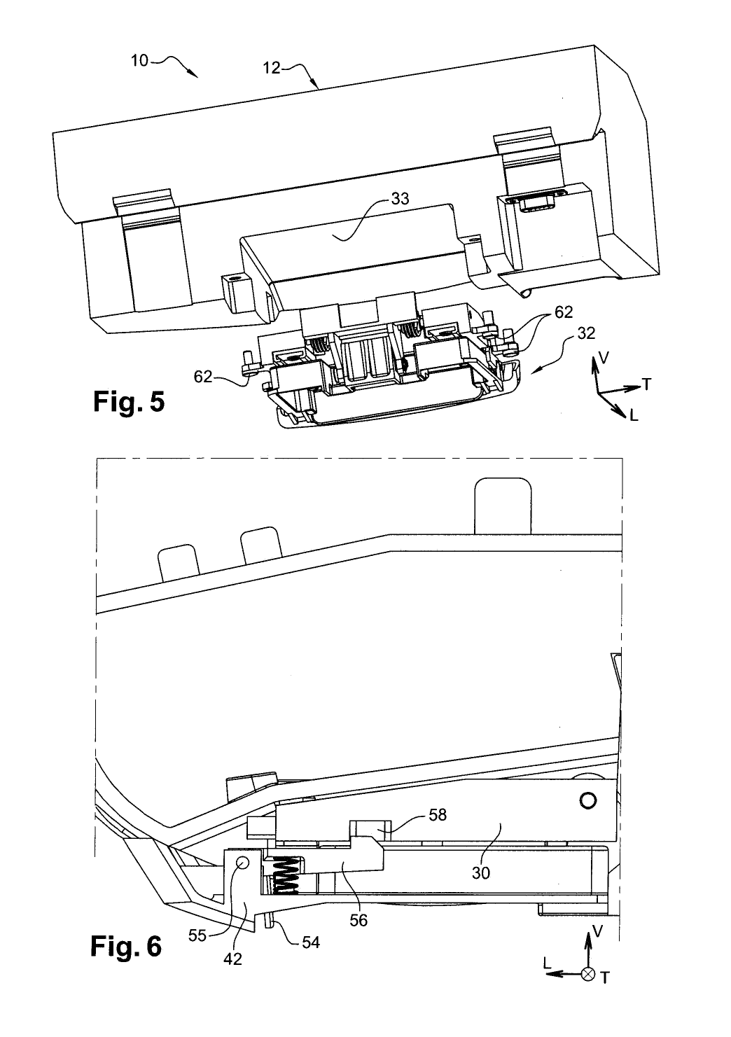

As is shown in FIG. 4, the jaw 26 and the control device 28 may be mounted on a common deck 30. The deck 30 may be fixed under a lower face of the housing 12, as is illustrated in FIG. 5. Thus, the jaw 26 and the control device 28 may form a module 32, which is fixed on an outer face 33 of the housing 12. This makes it possible in particular to easily service and repair the control device 28 without having to open the sealed housing 12. The module 32 is shown in more detail in FIG. 4. It may include, in particular, the upper deck 30. The deck 30 may be in the form of a horizontal panel.

The jaw 26 may be formed by two transverse vertical tongues, which are carried by a common crosspiece 34. More particularly, each tongue forming the jaw 26 may extend vertically upwards from a front end edge of the crosspiece 34. The crosspiece 34 also may carry two longitudinal vertical flanges 36, which extend vertically downwards from the lower face of the crosspiece 34.

The jaw 26 may be mounted so as to pivot on the deck 30 about a transverse shaft 38, which is arranged substantially at the level of the crosspiece 34. The elastic return of the jaw 26 to its clamping position may be effected by two torsion springs 40, which are engaged around the shaft 38, on either side of the flanges 36. Each torsion spring 40 may have a first end, which bears under the crosspiece 34, and a second end, which bears under the deck 30, in such a way as to return the jaw 26 elastically to its clamping position.

The control device 28 may include a drawer 42, which is mounted so as to slide longitudinally under the deck 30 by way of two lateral slides 44. For this purpose, the slides 44 may be fixed under the deck 30, for example by means of screws. The drawer 42 may thus slide between a rear clamping position, in which the jaw 26 occupies its clamping position, and a front release position, in which the jaw 26 occupies its position of release.

To permit the mechanical connection between the drawer 42 and the jaw 26, the drawer 42 may have a transverse channel 46, which is delimited longitudinally by two transverse walls. The channel 46 may open vertically towards the top and also transversely on both sides. In the clamping position, the channel 46 may be arranged vertically in line with the shaft 38 for pivoting the jaw 26. The channel 46 may then be received transversely between the two flanges 36.

A transverse rod 48 may be fixed between the lower ends of the two flanges 36. The rod 48 may thus pivot along with the jaw 26 about the shaft 38. The rod 48 may thus be received with longitudinal play in the channel 46. When the drawer 42 is pulled towards its front position of release, the rear wall of the channel 46 may transform the pulling force into a pivoting moment of the jaw 26 to its position of release. The rod 48 may slide vertically upwards inside the channel 46 in order to permit the transformation of the longitudinal sliding movement of the drawer 42 into a pivoting movement of the jaw 26. The drawer 42 may additionally include a front handle 50 allowing an operator to pull the drawer 42 to its position of release.

In addition, in the example shown in the figures, the control device 28 may include locking means for locking the drawer 42 in the clamping position thereof. The locking means may be elastic engagement means of complementary shapes. The locking means here may include a lever 52, which may be mounted so as to pivot under the drawer 42 about a transverse shaft 55. The lever 52 is shown in more detail in FIG. 6. The lever 52 may include a first, vertical actuation arm 54, which extends vertically downwards from the shaft 55. The first arm 54 may form a detent, which is arranged behind the handle 50 so as to be able to be pulled by an operator at the same time as the drawer 42.

The lever 52 also may include two second, longitudinal arms 56, which extend longitudinally rearwards from the shaft 55. Each second arm 56 may form a hook. The hooks 56 may be arranged transversely on either side of the drawer 42. Each hook 56 may be able to be engaged vertically upwards into an associated fixed notch 58 of the deck 30 when the drawer 42 is in its clamping position. The lever 52 may thus be mounted so as to pivot between an unlocked position, in which the hooks 56 are disengaged from their notches 58, and a locked position, in which the hooks 56 are engaged in their associated notch 58 in order to prohibit the sliding of the drawer 42 to its position of release with respect to the deck 30. The lever 52 may be returned elastically to its locked position. For this purpose, an associated spring 60 may be interposed vertically between each hook 56 and a face of the drawer 42.

As is shown in FIG. 5, the module 32 may be fixed to the lower face 33 of the housing 12 by way of the deck 30. In the example shown in the figures, the lower face 33 of the housing 12 may have a recess shape adapted to the module 32. Thus, the module 32 does not protrude below the housing 12. The deck 30 here may include four securing lugs 62, which are designed to receive screws for fastening to the housing 12.

According to an alternative embodiment (not shown) of the invention, the deck 30 may be fixed on the housing 12 by elastic snap-fit means of complementary shapes. Such a console 10 may thus be able to be mounted on a single rail 16A, 16B by virtue of modular fixing means. The module 32 may be easily dismantled without the need to open the housing 12 of the console 10. This makes the maintenance procedures easier.

According to another aspect of the invention, the console 10 described above may also be able to be mounted on two rails 16A, 16B of different dimensions. The two rails 16A, 16B may be arranged in the continuation of one another. In the example shown in the figures, the second rail 16B has a longitudinal thickness greater than that of the first rail 16A. In addition, the second rail 16B has a vertical height less than that of the first rail 16A. The groove 18 has a longitudinal width sufficient to accommodate the thicker second rail 16B. In addition, the two rails 16A, 16B are fixed here in such a way that the upper edge of the first rail 16A is arranged above the level of the upper edge of the second rail 16B. The front faces of the two rails 16A, 16B are coplanar here.

To provide for the console 10 to straddle the join between the two rails 16A, 16B, the rear wall 24 of the groove 18 may have a stepped shape. Thus, the wall 24 may have a horizontal shoulder face 64. Above the level of the shoulder face 64, the groove 18 may have a longitudinal width substantially equal to that of the first rail 16A, whereas, below the level of the shoulder face 64, the groove 18 may have a longitudinal width substantially equal to that of the second rail 16B. Thus, the console 10 may be able to bear vertically on the two rails 16A, 16B simultaneously. More particularly, when the console 10 straddles the join between the two rails 16A, 16B, the shoulder bears on the first rail 16A, and the base 20 of the groove 18 bears against the rear face of the second rail 16B. This allows the console 10 to maintain a horizontal attitude regardless of which rail 16A or 16B it is attached to. This also allows the console 10 to maintain a horizontal attitude when it is attached simultaneously to the two rails 16A, 16B by straddling the join.

When the console 10 thus straddles the join between the two rails 16A, 16B, the jaw 26 may bear against the second, thicker rail 16B. The groove 18 also may include, in an upper part of its front face 22, a clearance 66 that allows the console 10 to be tilted with respect to the rail 16A, 16B when the jaw 26 is in the position of release, in order to make it easier for the console 10 to be attached to or detached from the rail 16A, 16B. The tilting of the console 10 may make it possible in particular to cause the jaw 26 to move to the position of release underneath the rails 16A, 16B.

According to an alternative embodiment (not shown) of the invention, the clearance may also be applicable to a monorail console that has no stepped arrangement. The stepped profile of the groove 18 thus makes it possible to obtain a very stable hold of the console 10.

According to an alternative embodiment (not shown) of the invention, the stepped shape of the rear wall may be replaced by a slope. This allows the console to be adapted to several sizes of rails.

The dimensions of the steps may be determined on the basis of the dimensions and arrangement of the rails 16A, 16B. The dimensions of the rails 16A, 16B are thus assumed to be known during the designing of the groove 18.

During the use of the console 10, an operator may pull the drawer 42 in order to make it slide towards its front position of release. This has the effect of causing the jaw 26 to tilt towards its position of release. It is thus possible to attach the console 10 by way of its groove 18. By means of a tilting movement of the console 10 about a longitudinal axis permitted by the clearance 66, the jaw 26, in the position of release, may pass under the rails 16A, 16B. The console 10 may then be let go by the operator. The weight of the console 10 may make it possible to stabilize the console 10 in its position of use. The jaw 26 and the drawer 42 may then be returned elastically to their position of clamping the rail 16A, 16B between the jaw 26 and the rear face 19 of the console 10. The console 10 is thus fixed by clamping on the rail 16A, 16B.

By means of the crosspiece 34 that carries the jaw 26, it may be possible to ensure that the console 10 cannot be moved vertically upwards with respect to the rail 16A, 16B. Indeed, if an attempt is made to lift the console 10, the crosspiece 34 may come into contact with the lower edge of the rail 16A, 16B in order to block the upward movement of the console 10.

When it is desired to move the console 10 on the rail 16A, 16B, it may be possible to pull the drawer 42 towards its position of release. The jaw 26 is therefore no longer clamped against the rail 16A, 16B, and it may be possible to slide the console 10 along the rail 16A, 16B without detaching the former.

By virtue of the stepped shape of the groove 18, it may possible to slide the console 10 from one rail 16A to the other rail 16B, situated in the continuation thereof, without detaching the console 10. For an operator, this transfer of the console 10 from one rail 16A, 16B to the other may be done in the same way as sliding the console 10 on a single rail 16A, 16B. Moreover, the arrangement of the module 32 outside the housing 12 may greatly simplify the maintenance procedures performed on the control device 28, without compromising the integrity of the control electronics contained in the housing 12.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A control console designed to be slidably mounted on at least a first transverse rail, the console comprising:
a sealed housing comprising a transverse groove designed to be attached to the first transverse rail; and
a jaw movably mounted on the sealed housing and configured to transition between a lock position and a release position, wherein the first transverse rail is clamped between the jaw and a rear face of the sealed housing to immobilize the sealed housing with respect to the first rail when the jaw is in the lock position, and wherein the sealed housing is able to be withdrawn from the first rail when the jaw is in the release position;
wherein the jaw is mounted movably on a deck fixed on an outer face of the sealed housing.

2. The console of claim 1, wherein the jaw is configured to be actuated by a control device.

3. The console of claim 2, wherein the outer face of the sealed housing is configured as a recess in which the jaw and the control device are received.

4. The console of claim 3, wherein the control device and the jaw are mounted on a common deck, thereby forming a module designed to be fixed against the outer face of the sealed housing.

5. The console of claim 1, wherein the jaw is configured to return elastically to the lock position.

6. The console of claim 1, wherein movement of the jaw to the release position is controlled via a drawer mounted so as to slide horizontally on the deck.

7. The console of claim 6, wherein the drawer comprises a locking mechanism for locking the jaw in the lock position.

8. The console of claim 6, wherein the drawer is configured to slide longitudinally under the deck.

9. The console of claim 1, wherein:
the console is further configured to be mounted on a second transverse rail and be immobilized on the second transverse rail by the jaw, wherein the second rail is thicker in width that the first transverse rail; and
the groove is sized to accommodate the second transverse rail.

10. The console of claim 9, wherein the second rail is arranged as a continuation of the first rail such that:
the second transverse rail comprises an upper face arranged below a level of an upper face of the first transverse rail; and
the groove comprises a stepped profile to permit simultaneous bearing of the stepped profile on the first transverse rail and the bearing of a base of the groove on the second transverse rail when the console straddles a join between the first transverse rail and the second transverse rail.

11. The console of claim 1, wherein the jaw comprises a corner configured to immobilize the console in all directions with respect to the first transverse rail.

12. The console of claim 1, wherein the groove comprises a clearance configured to facilitate tilting of the console with respect to the first transverse rail when the jaw is in the release position to facilitate attachment to or detachment from the first transverse rail.
